(19) United States
(12) Patent Application Publication
(10) Pub. No.: US 2011/0116738 A1
(43) Pub. Date: May 19, 2011

(54) ELEMENT MOUNTED DEVICE AND METHOD FOR MANUFACTURING ELEMENT MOUNTED DEVICE

(76) Inventor: SHINYA WATANABE, Tokyo (JP)

(21) Appl. No.: 12/940,814

(22) Filed: Nov. 5, 2010

(30) Foreign Application Priority Data
Nov. 13, 2009 (JP) 2009-259436

(51) Int. Cl. G02B 6/122; G02B 6/13

(52) U.S. Cl. 385/14; 29/840

(57) ABSTRACT

An element mounted device comprising a substrate with a pedestal and a convex portion whose height is lower than the pedestal on the surface, and a first element mounted on the pedestal and fixed to the substrate by a first AuSn solder.

And a part between the area of the first element opposing to the convex portion and the convex portion, is filled with a second AuSn solder which is Au-richer than the first AuSn solder.

This application is based upon and claims the benefit of priority from Japanese Patent Application No. 2009-259436, filed on Nov. 13, 2009, the disclosure of which is incorporated herein in its entirety by reference.

### TECHNICAL FIELD

The present invention relates to element mounted device, and in particular, relates to element mounted device aligned with high precision on the height direction and the horizontal direction.

### BACKGROUND ART

The optical module which is equipped with optical waveguide (or optical fiber) and photonic element in such a way that both elements are coupled optically, is the device to transmit optical signal emitted from photonic element to external portion via optical waveguide (or optical fiber), and to receive optical signal from external portion by photonic element. Transmission of optical signal is performed by injecting electric current to laser diode (hereinafter referred to as “LD”) and making LD to emit light. Reception of optical signal is performed by receiving optical signal at photodiode (hereinafter referred to as “PD”) and producing photocurrent. In order to improve the efficiency of optical coupling, a lens may be put into, or filter or optical isolator for removing extra light may be provided, between an optical waveguide (or an optical fiber) and a photonic element. Various mounting structures are employed depending on the route of intended optical communications. For example, the modules for optical communications of trunk line which connects large cities are mounted optical components such as lenses and optical isolators together with optical elements and optical fibers. But optical modules for subscriber line may not be used such optical components to reduce costs.

When mounting optical element, optical element may be fixed by solder to substrate which is equipped with optical waveguide. Or optical fiber may be fixed on substrate after fixing optical element on substrate by solder. Here, for the optical coupling of optical waveguide (or optical fiber) and optical device, the precision of the position, the height, and the levelness of the optical element is important. Especially in subscriber line of optical communications, it is indispensable to assemble optical module at low cost. And for coupling an optical element with an optical waveguide directly without lens, high precision alignment is required.

The optical module of subscriber line uses the substrate in which waveguide is formed on Si substrate, and metalized electrodes are formed on the optical element mounted part at the edge of said waveguide, further, thin-filmed AuSn solder of several mm of thickness is formed by evaporation on the metalized electrodes. Then, alignment is performed using indexes (alignment markers) which are formed on both of optical element and substrate in advance. After this, the optical element is fixed temporarily by being pressed on AuSn solder film. After a plurality of optical elements is fixed temporarily, the substrate is heated more than the melting point of the AuSn solder. As a result, a plurality of optical elements is connected to the electrodes all together. Such mounting method aligned by alignment marker without optical axis adjustment is called passive alignment mounting.

In passive alignment mounting, the positional precision of the horizontal direction about a waveguide chip is secured by recognizing the image of alignment marker with infrared rays. The precision of the vertical direction is secured by the height of the pedestal blocks. Because the height of the pedestal blocks can be controlled very precisely, the height of the optical axis of the optical elements (components) such as LD and PD can be aligned very precisely with the height of the optical waveguide, only by mounting those optical elements (components) on the pedestal.

For example, in Japanese Patent Publication No. 2823044, an optical device having an LD element mounted on a PLC (Planar Lightwave Circuit) chip whose optical waveguide circuit is made by microfabrication technology of a semiconductor manufacturing process is disclosed. The heights of the waveguide core and the pedestal are controlled only by the precision of the thickness of the film which is formed with film deposition system. And because both heights can be aligned very precisely, by mounting a LD element on a pedestal, precise optical coupling of the LD and the waveguide core is realized without adjustment of the optical axis. In such structure, if a required number of the pedestal and the alignment marker are formed at each required place, a plurality of optical elements can be mounted on PLC by passive alignment mounting.

To an optical waveguide device, LD, PD, SOA (Semiconductor Optical Amplifier), modulator chip, and other various optical elements are mounted. It is expected that the depths of the active layer of those optical elements (semiconductor chip) mounted on such optical waveguide device differ from each other. In such case, in order to align the optical axis, it can be considered that pedestals with different height corresponding to each element are made.

In such case, the following problem is assumed. That is, when an optical element (a semiconductor chip) is mounted on an optical waveguide chip by flip chip mounting, AuSn eutectic solder is used for fixation. This is because the melting point of AuSn solder is high compared with other solder material, therefore the mounting at an early assembly stage is possible. Further, it is because high reliability can be obtained because AuSn solder is a hard and stable material. On the other hand, because it is necessary to align the optical axis, such optical elements are not fixed simultaneously on an optical waveguide chip differently from a reflow mounting process of electrical component to a printed wiring board, and each element is mounted by passive alignment in order. However, because the above stated pluralities of optical element are fixed by same AuSn solder, the AuSn solder to fix an optical element on ahead may be fused at the time of later heating fixation of another optical element, and then a positional replacement of the fixed optical element may arise.

As a technology to improve the heat resistance of AuSn solder to fix elements, for example Japanese Patent Laid Open No. 2003-200289 discloses the art of thermal diffusion of Au into AuSn solder from the adhesive interface by forming Au layer on the surface of the element which is to be mounted. As a result, Au-rich layer having high melting temperature is formed at the neighborhood of the adhesive interface with the element, and it becomes possible to improve the heat resistance of the bonding strength between the element and the AuSn solder. However, it is limited to the near surface of AuSn solder to form Au-rich layer. Therefore, in the case of an optical element needs to fix with thick AuSn solder, when most of AuSn solder melts by heating, even the strength around the adhesive interface between the optical element and the AuSn solder is kept, it is difficult to prevent a positional displacement of the optical element.

As the art in order to solve such problem, for example, Japanese Patent Laid Open No. 2002-111113 (hereinafter referred to as “patent document 1”) discloses the art to fix elements with solder in the state of temporary fixing of elements with a bump composed of Au, Ag, Cu, Ni, Pt, Pb, and Al, or an alloy of those.

### SUMMARY

An exemplary object of the present invention is to provide an element mounted device and a method for manufacturing an element mounted device, which can adjust the positions of height direction and the horizontal direction precisely when element is mounted.

An element mounted device according to an exemplary aspect of the invention includes a substrate with a pedestal and a convex portion whose height is lower than the pedestal on the surface, and a first element mounted on the pedestal and fixed to the substrate by a first AuSn solder, wherein a part between the area of the first element opposing to the convex portion and the convex portion, is filled with a second AuSn solder which is Au-richer than the first AuSn solder.

A manufacturing method for element mounted device with a first element mounted on a substrate according to an exemplary aspect of the invention includes the steps of structuring a pedestal on said substrate, structuring a convex portion whose height is lower than said pedestal on said substrate, setting Au layer on said convex portion, setting AuSn solder on said substrate in such a way that said AuSn solder covers said convex portion arranging a first element on said substrate, and heating said substrate in such a way that: when said first element arranged on said substrate is fixed to said substrate by AuSn solder set on said substrate, Au from Au layer set on said convex layer diffuses into said AuSn solder, and Au rich part which does not melt at the melting temperature of AuSn solder is structured between said convex portion and said first element.

### BRIEF DESCRIPTION OF THE DRAWINGS

Exemplary features and advantages of the present invention will become apparent from the following detailed description when taken with the accompanying drawings in which:

FIG. 1 is a cross-sectional view showing a composition of an element mounted device of the first embodiment of the present invention;

FIG. 2 is a cross-sectional view showing an outline of the main part of an optical waveguide device of the second embodiment of the present invention.

### EXEMPLARY EMBODIMENT

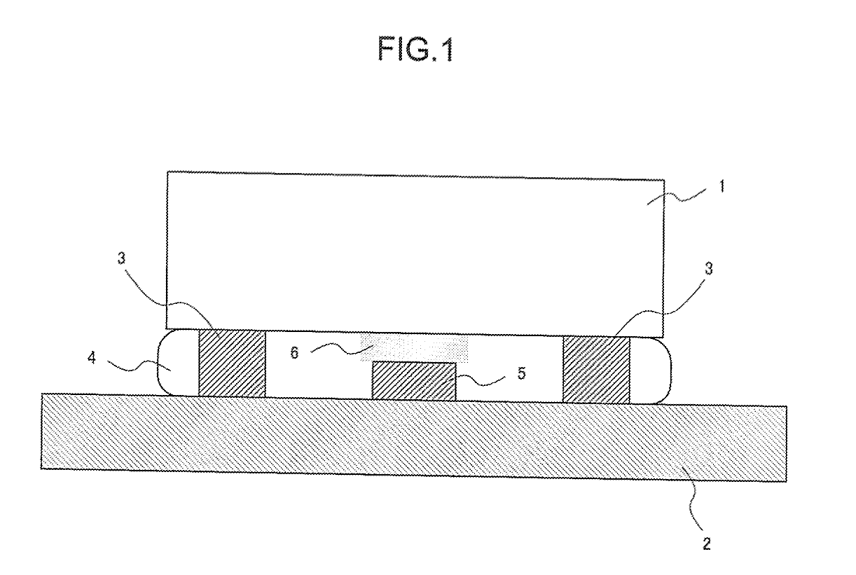

Next, the first embodiment of the present invention will be described below with reference to FIG. 1.

FIG. 1 is a cross-sectional view showing a composition of an element mounted device of the first embodiment. The element mounted device comprises substrate 2 with pedestal 3 and convex portion 5 whose height is lower than pedestal 3 on the surface, and the first element 1 mounted on pedestal 3 and fixed to substrate 2 by the first AuSn solder 4. Further, a part between the area of said first element 1 opposing to convex portion 5 and convex portion 5 is filled with the second AuSn solder 6 which is Au-richer than the first AuSn solder 4.

In a configuration as described above, because there are a lot of Au components in the second AuSn solder 6, the melting temperature becomes high and it does not fuse at the temperature of the first AuSn solder 4 to fuse. As a result, even by having a heating treatment to fuse the first AuSn solder, it is possible to adjust the positions of the height direction and the horizontal direction very precisely when element is mounted, because the first element 1 is fixed certainly on convex portion 5.

Next, the second embodiment of the present embodiment will be described.

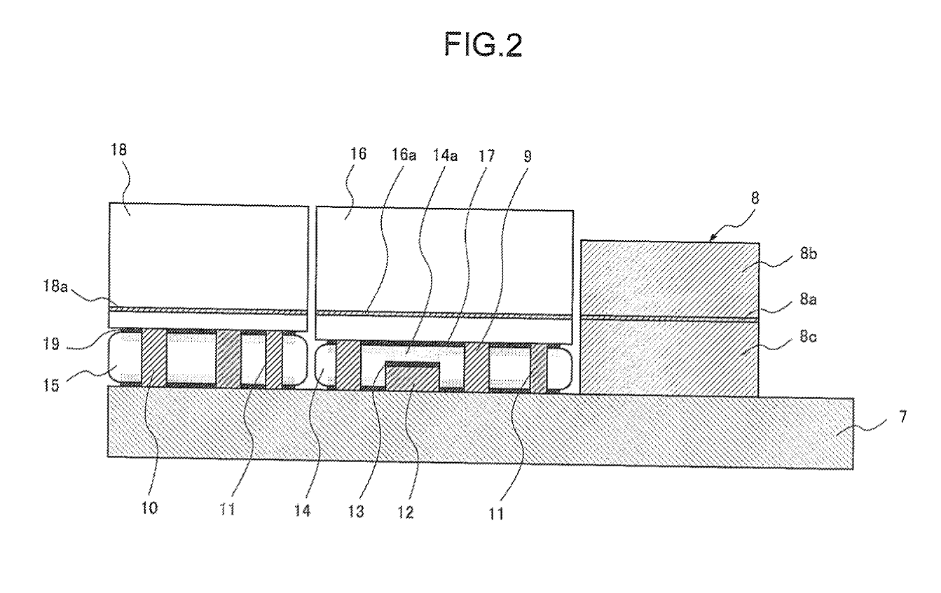

FIG. 2 is a schematic cross-sectional view of the main part of an optical waveguide device having LD and SOA for example as optical element being mounted by passive alignment on the same optical waveguide chip. Optical waveguide 8 formed on Si substrate 7 is constituted from optical waveguide core 8a, over optical waveguide clad 8b, and under optical waveguide 8c.

Pedestals 9 and 10, alignment marker II, and anchor 12 which are made from SiO₂ are formed at the same time by microfabrication technology having a publicly known semiconductor manufacturing process applied to. The height of pedestal 9 and 10 and the height of alignment marker 11 are set as to be the same height as active layer 16a of LD 16, active layer 18a of SOA 18, and optical waveguide core 8a.

There is a significant feature in the structure of which the height of anchor 12 is had been lower than pedestal 9. For example, it is possible to have the height of pedestal 9 from 0.1 μm to 2 μm higher than anchor 12. In the present embodiment, the height of pedestal 9 is set 1 μm higher than anchor 12.

On the upper surface of substrate 7 in a predetermined position, and on the upper surface of anchor 12, Au pad 13 which is made by evaporation means is being set. The thickness of Au pad 13 is for example 0.3 to 1 μm. In the present embodiment, the thickness of Au pad 13 is made 0.3 μm. Likewise, on the lower surface of LD 16 and SOA 18, Au pad 17 and 19 are set respectively. The thickness of Au pad 17 and 19 are for example 0.3 to 1 μm. In the present embodiment, the thickness of Au pad 17 and 19 are made 0.3 μm respectively.

While AuSn eutectic solder 14 and 15 can be set by, for example, dry plating means such as evaporation means or sputtering means, in the present embodiment, ribbon solder is mounted on substrate 7 by punching through with punch. Further, the AuSn eutectic solder being used in the present embodiment is Au:Sn=80:20 (mass ratio). In addition, at the part between anchor 12 and after-mentioned LD 16, Au diffuses thermally into AuSn eutectic solder from Au pad 13 or Au pad 17 by heating, and AuSn eutectic solder becomes Au rich. That is, because the thickness of the AuSn eutectic solder is thin in the part between anchor 12 and LD 16, by the Au which moves by the thermal diffusion from Au pad 13 or after-mentioned Au pad 17 on anchor 12, the entire part of the AuSn eutectic solder of this part becomes Au rich. On the other hand, for other part, because the AuSn eutectic solder is thick, the diffusion of Au from Au pad 13 on the surface of substrate 7 does not reach to depth of AuSn eutectic solder. This point shows that an anchor 6 of the present embodiment is playing a very important role. Au rich part 14a which is the Au rich area of the AuSn eutectic solder is shown as a shaded area in FIG. 2. Au rich part 14a is constituted from ζ layer where the eutectic state is annihilated, and does not melt at the melting temperature of the usual AuSn solder.

Next, a manufacturing process of an optical waveguide device (a passive alignment mounting process) of the aforementioned structure is described. Here, the case of mounting LD 16 prior to the mounting of SOA 18 will be described.

At first, pedestals 9 and 10, alignment marker 11, and anchor 12 are structured on Si substrate 7 by microfabrication technology applied to publicly known semiconductor manufacturing process. In addition, the height of pedestal 9 and 10, alignment marker 11, and anchor 12 are set as aforementioned, respectively.

Next, Au pad 13 is structured by evaporating Au on the surface of substrate 7 at the position corresponding to the mounting position of LD 16 and SOA 18.

Afterwards, a bump of AuSn is put on Au pad 13. At this moment, anchor 12 is buried in the bump of AuSn.

Next, similar to general passive alignment mounting process, the position is decided so as to match both markers for alignment, which formed on the optical waveguide chip and on LD chip by Au plating, by checking both of them with infrared light from the back of a substrate.

After the position is decided, LD 16 is contacted to AuSn bump and the predetermined load is added to LD 16. Then, after confirming that a misalignment is not occurring, it is heated to more than 280° C. (greater than the melting temperature of the AuSn bump). Afterwards, it will be naturally cooled to room temperature. As a result, LD 16 is fixed to substrate 7 with fused and fixated AuSn.

Afterwards, similar to the abovementioned process, SOA 18 will be passive alignment mounted. For the mounting of SOA 18, Au of Au pad 13, 19 invades AuSn eutectic solder of which the portion between anchor 12 and LD 16 by thermal diffusion. That is, Au rich part 14a is constituted. Au rich part 14a is to be ζ layer which is not fused by the melting temperature of the AuSn solder. As a result, LD 16 is fixed certainly by Au rich part 14a that is not fused even by the heating of when mounting SOA 18, and the position shift of LD 16 is not occurred.

In the present embodiment, when mounting a plurality of elements respectively to be fixed by AuSn solder, the position adjustment of the height direction and the horizontal direction of each element can be performed with high degree of precision.

While the art disclosed in the aforementioned patent document 1, it is effective for preventing the misalignment of the horizontal direction when element is mounted, there is the problem of having a limit of the precision on misalignment in the height direction. That is, because the diameter of the bump used for temporary fixing of an element has about 60 μm of size, it is difficult to mount an optical element to align optical axis with an optical waveguide core formed in the height about 10˜15 μm on the substrate. Further, even if the height of a bump is matched, it is extremely difficult to mount a plurality of bumps into a certain height. Therefore, it was difficult to mount a plurality of optical elements with a high degree of precision using the art disclosed in the patent document 1.

In contrast, even when mounting a plurality of elements, the present invention can align the height direction and the horizontal direction of each element with a high degree of precision.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

1. An element mounted device comprising:
a substrate with a pedestal and a convex portion whose height is lower than said pedestal on the surface; and
a first element mounted on said pedestal and fixed to said substrate by a first AuSn solder;
wherein a part between the area of said first element opposing to said convex portion and said convex portion, is filled with a second AuSn solder which is Au-richer than said first AuSn solder.

2. An element mounted device according to claim 1, wherein said second AuSn solder is constructed from ζ layer of which eutectic state is annihilated, which does not melt even at the melting point of AuSn eutectic solder.

3. An element mounted device according to claim 1, wherein said convex portion is structured in such a way that thickness L of said second AuSn solder part is to be 0<L≦2 μm.

4. An element mounted device according to claim 1, wherein:
said first element is a first optical element; and
a second optical element and a optical waveguide are comprised further, which are optically coupled to said first optical element respectively.

5. A manufacturing method for element mounted device with a first element mounted on a substrate, comprising the steps of:
structuring a pedestal on said substrate;
structuring a convex portion whose height is lower than said pedestal on said substrate;
setting Au layer on said convex portion;
setting AuSn solder on said substrate in such a way that said AuSn solder covers said convex portion;
arranging a first element on said substrate; and
heating said substrate in such a way that:
when said first element arranged on said substrate is fixed to said substrate by AuSn solder set on said substrate, Au from Au layer set on said convex layer diffuses into said AuSn solder, and Au rich part which does not melt at the melting temperature of AuSn solder is structured between said convex portion and said first element.

6. A manufacturing method for element mounted device according to claim 5, wherein:
the step of structuring a substrate side alignment marker on said substrate is comprised further; and
in said step of arranging a first element, the fixing position of said first element is decided by checking the positional relation between said substrate side alignment marker and the element side alignment marker which set to said first element in advance.
